(19) United States
(12) Patent Application Publication
(10) Pub. No.: US 2015/0051720 A1
(43) Pub. Date: Feb. 19, 2015

(54) ATHLETE TRAINING, INFORMATION GATHERING, AND INFORMATION RECORDING APPARATUS

(71) Applicant: JAMES EDWARD GENTEMAN, LOYAL, WI (US)

(72) Inventor: JAMES EDWARD GENTEMAN, LOYAL, WI (US)

(21) Appl. No.: 14/459,249

(22) Filed: Aug. 13, 2014

Related U.S. Application Data
(60) Provisional application No. 61/865,808, filed on Aug. 14, 2013.

(51) Int. Cl. G06K 9/00

(52) U.S. Cl. CPC G06K 9/00342
USPC 700/91

(57) ABSTRACT

The present invention describes an athletic training apparatus which automatically gathers and records timing information, statistical data, and other related information for an unlimited, specified number of participants. The athletic training apparatus provides a keyboard, display, speaker, motion sensor, laser projector, and USB/communication interface, and is configured to provide a projected visible starting line, gather, measure, and record false starts, race start reaction times, and elapsed racing times of athletes, and maintain additional information for an arbitrary number of athletes. The disclosed athletic training apparatus is also highly customizable in regard to audio and visual indications, delays, data record formats, and information transfer and storage methodologies.

### PRIORITY

This application claims the benefit of U.S. Provisional Application No. 61/865,808, filed Aug. 14, 2013.

### BACKGROUND OF THE INVENTION

1. Field of the Invention

The current invention is directed to an apparatus which can improve the performance and training of an athlete of various timed sporting events, including track and field events, swimming, and cycling. The current invention enables a set of athletes to accurately measure and track performance parameters of timed racing, record environmental, conditional, and equipment factors on overall performance, and automated visual and audible indications for a timed race or trial initiation.

2. Description of the Related Art

Athletes who race against time or other athletes over a fixed distance predate civilization itself. The preparation, positioning, and gathered knowledge which a runner makes prior to a race beginning impacts the performance of the runner over the duration of the race. For example, track and field athletes must be aware of a wide array of factors which may impact their overall performance in order to be highly successful while racing or training. Among these factors, positioning at the start line, reaction time once the race has begun, environmental conditions, and equipment being relied upon, all impact the performance of an athlete in a given race.

Often, an athlete preparing at the start of a running race or trial is unable to visualize themselves from a different point of view. This makes it difficult or impossible for an athlete to observe themselves at the beginning of a race to isolate potential aspects of their performance which may be improved by focused training. Further, an athlete waiting for a race to begin is simply unsuited to gather and record information related to their own pre-race and race start activities, including reaction times and potential false-starts.

For many athletes, there is great value in being able to measure and record activity during various sporting events. Among these, track and field athletes can greatly improve running times and overall performance by accurately measuring, recording, and tracking various variables of their performance, including response/reaction times during the first few seconds of a race, in addition to overall race times. Additionally, various external factors may also impact the performance of the runner, including wind, moisture, track conditions, and even the type of shoes being worn.

Many athletes wisely utilize coaches or training partners to record and track performance parameters. However, these individuals also introduce another level of complexity in gathering accurate statistical information, including inaccuracies in timing at race start and finish. Aside from any accuracy concerns, measurement and correlation of data for multiple athletes in this context can be complicated and time consuming. There is also an associated time and material cost when resorting to manually generated or written performance logs for reaction, timing, and associated environmental data when working with a multitude of athletes, even when using a computer interface for record keeping.

Often, there may also be inconsistencies with where a given race start line is defined, and when a starting “gun” sound is generated or heard by a runner. The issue of a predictable race start indicator may also become important for collecting accurate information. When a particular set of runners improperly gain an advantage over other athletes by memorizing timing delays between a pre-race indicator and the race begin indicator, reaction time recording becomes less meaningful.

The present invention relieves a great deal of these problems of the prior art by providing an apparatus which can simultaneously measure and record critical aspects of the performance data for a plethora of athletes, while correlating all relevant data for each athlete and event as it is collected in a standardized fashion. This allows not just one, but an entire set of athletes to isolate any particular aspects of their training which can be improved with greater precision. Further, a defined and visible starting line can be projected from the apparatus, in combination with an integrated audio system and a sensor for detecting motion, making measurement of reaction times more consistent when race start reaction information and timing for multiple runners is being gathered.

One prior art device is known which addresses some of these issues, including providing a pre-race start signal and a race start signal simulating an actual race event starting condition. U.S. Pat. No. 6,072,751, published Jun. 6, 2000, to Allan Kirson et al., describes a device which implements an electronic central processing unit which communicates with one or more finish line units using a communication link to time and records racing events, determine reaction times of runner(s), provides an audio pre-race start signal and race start signal, and measures weather and atmospheric conditions and storing this information for future processing and review of this information as training statistics. However, one feature this particular device lacks is the ability to project a starting line which can be used as a standardized reference point for all runners. Another deficiency of the Kirson device is the reliance upon external computing units to relay motion detection and collect timing information.

The prior art as a whole fails to address the entirety of all the problems known in the art as detailed above. The present invention serves to address many, if not all, of these issues, removing as many inconsistencies and inaccuracies as possible from data collection of a multitude of athletes in track and field and other timed events.

### SUMMARY OF THE INVENTION

The present invention describes an apparatus used for athletic training, providing improved gathering and recording of information and statistical data relating to an unlimited, specified number of participants. The current invention is applicable to track and field runners, as well as other types of timed athletes, including cyclers or swimmers.

In one embodiment of the invention, the apparatus provides user input device(s) for gathering information, a liquid crystal display (LCD) for displaying information, and an audio interface for audibly broadcasting information. The apparatus can be programmed to act in different modes for an unlimited, specified number of runners, including an automatic mode for automated information gathering at the start of the race/event/trial, and a stop watch mode for gathering and recording timing information at the conclusion of a race/event/trial.

In another embodiment of the invention, the apparatus may be manually configured for a given number of runner(s) or participants, date and time, programmed or random time delays between runner(s) or starts, ambient motion/noise levels for comparative determinations for required/desired volume and/or false starts, and programmable sounds for use with the audio interface. In this embodiment, the apparatus may be additionally configured to provide various audio indications to the runner(s) to indicate pending or current actions on behalf of the runner(s).

In another embodiment of the invention, the apparatus is configured to perform active recording of a wide variety of information for current or later analysis for an unlimited, specified number of runners, including start time responses/reaction times, running times, outfitted equipment, etc., as well as environmental factors like weather conditions, ambient sound and light, track conditions, etc., associated with a particular running time or event trial.

In another embodiment of the invention, the apparatus is configured to project a visual starting line for runners to visually reference to set and prepare for an upcoming race start.

In another embodiment of the invention, the apparatus is configured to detect false starts by runner(s) moving before or during a given race starting procedure or interval. The invention is further configured to create interval durations randomly during the race starting procedure to prohibit improper prediction of race start intervals or indication of race start.

In another embodiment of the current invention, an integrated motion detector module is used to indicate motion for identifying false starts, reaction times, and trial completion.

In another embodiment of the invention, the apparatus is configured to transmit gathered and stored information to a remote memory module and/or computer for temporary or long term storage and/or processing.

The above and other aspects of the invention will become better understood with regard to the following detailed description of the preferred embodiments, but it is understood these embodiments are not specifically limiting. Further, the specific structure of each component of each embodiment is also intended to be non-limiting, unless specifically specified. The following description is made with reference to the accompanying drawings.

### BRIEF DESCRIPTIONS OF THE DRAWINGS

FIG. 1 is a block diagram of one embodiment of the apparatus;

FIG. 2A is a schematic of the central processing unit module and associated circuitry in accordance with one embodiment of the invention;

FIG. 2B is a schematic of a power supply module in accordance with one embodiment of the invention;

FIG. 2C is a schematic of a laser beam module in accordance with one embodiment of the invention;

FIG. 3. and FIG. 4 display a flow diagram of the processing of the apparatus in accordance with one embodiment of the invention.

### DETAILED DESCRIPTION OF THE INVENTION

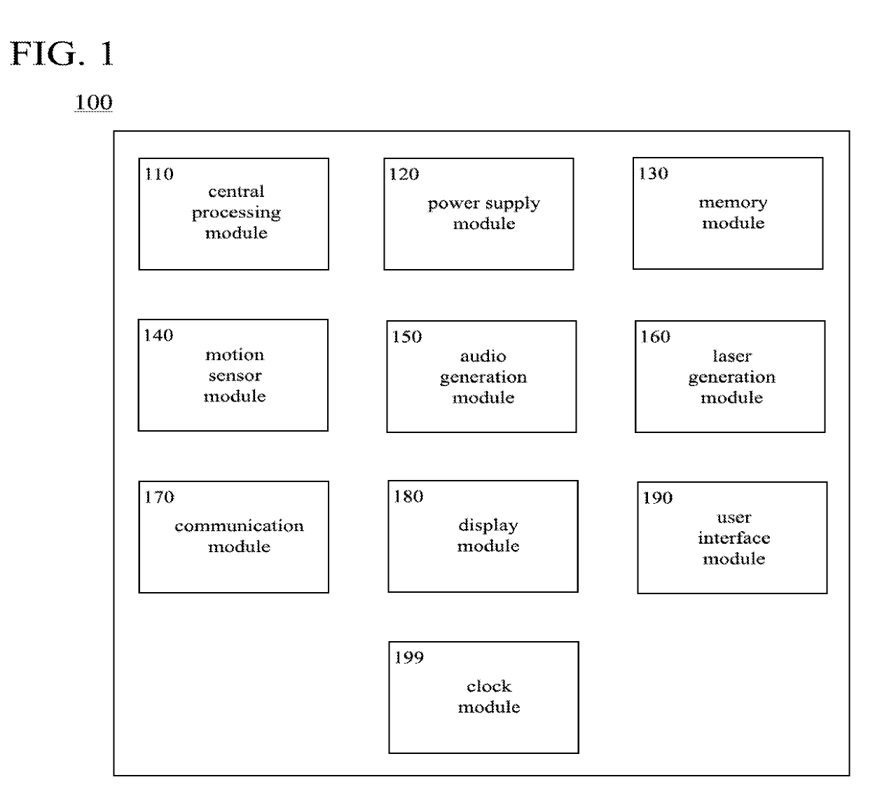

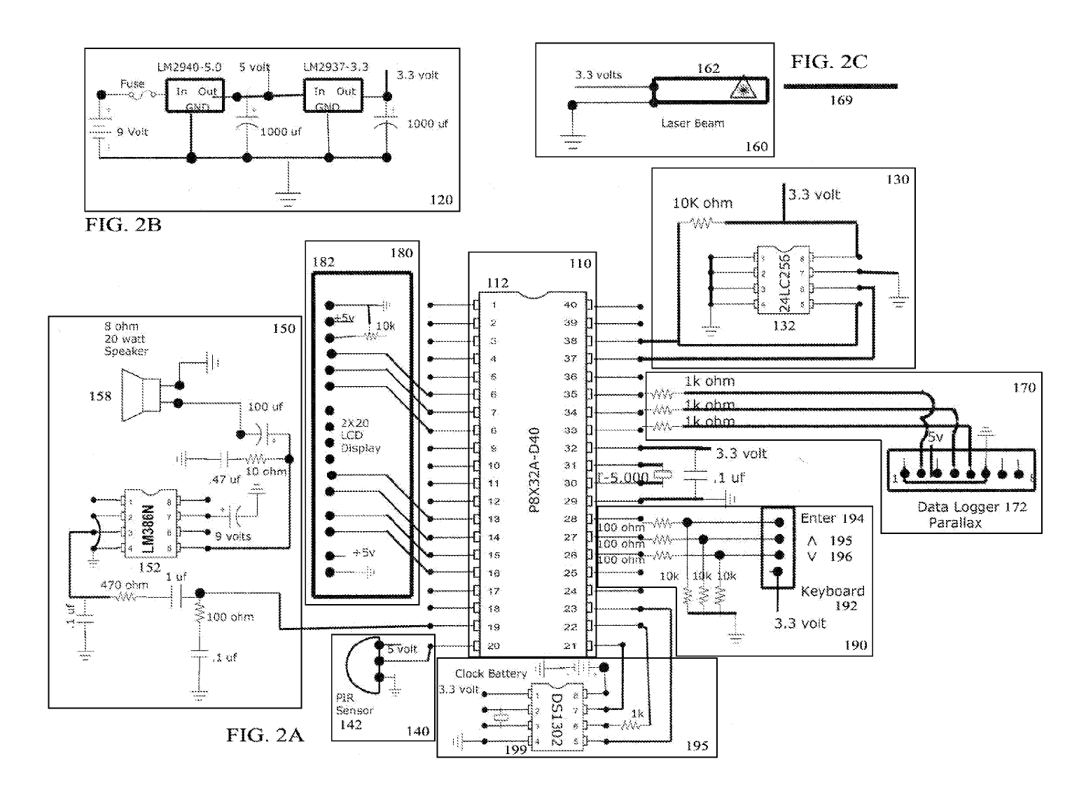

Referring to FIG. 1, training apparatus 100 is shown in accordance with one embodiment of the present invention which includes central processing module 110, power supply module 120, memory module 130, motion sensor module 140, audio generation module 150, laser generation module 160, communication module 170, display module 180, user interface module 190, and clock module 199. Various logical elements shown in FIG. 1 are shown in FIG. 2A-2C in accordance with one embodiment of the invention.

Referring to FIG. 2A, central processing module 100 may be realized by a wide variety of microcontrollers/microprocessors, including Arduino, Raspberry Pi, and other well known microcontrollers in the art. The present embodiment uses a “Propeller Chip”, the P8X32A-D40 microcontroller 112 supplied by Parallax Inc. of Rocklin, Calif., having 8 reduced instruction set computing (RISC) processors and 32 addressable input/output (I/O) pins. Referring to FIG. 2A, pins 9-12 and pins 29-32 of the P8X32A-D40 microcontroller are reserved, providing Power Input VDD (pin 12, 32), Ground VSS (pin 9, 29), Brown Out Enable (connected to VDD or VSS) (pin 10), Reset (pin 11), Crystal Input (pin 30), and Crystal Output (pin 31).

Memory module 130, which is realized in the present embodiment by the 24LC256 EEPROM 132, manufactured by Microchip Technology Inc. of Chandler, Ariz., stores all programmed instructions (generated in high level programming language like SPIN), in addition to information gathered by training apparatus 100. Other minor electronic components may be required in memory module 130 to enable proper functionality (as shown), but these details regarding all such non-specific components are omitted for the sake of brevity, and are generally known to those skilled in the art.

Of course, firmware or any other type of non-volatile memory module(s) (not shown) may be used to store programmatic instructions and/or information for the training apparatus 100 without departing from the spirit and scope of the invention. After powering up, volatile memory module(s) (not shown) may also be used for program and information storage provided any necessary information is copied to the utilized memory module(s) during initialization. The current embodiment uses a specific configuration of specialized hardware components and modules which are suitably programmed to achieve the described methods and actions. In one embodiment, the apparatus as a whole contains functional components which cannot be reprogrammed “on the fly”, providing a statically defined piece of computing equipment which cannot be easily tampered with or reprogrammed to provide inaccurate or misleading information. This may include firmware or other non-programmable non-volatile memory and associated modules.

Motion sensor module 140 may be realized by a variety of types of motion sensor devices. As shown in FIG. 2A, the present embodiment utilizes a high sensitivity passive infrared sensor (PIR sensor) 142 which monitors movement using infrared light, although any type of motion sensor which can effectively report motion may be implemented without departing from the spirit and scope of the invention.

Audio generation module 150 may consist of any combination of sound generating equipment, for example, a generic audio amplifier and loudspeaker (not shown). As shown in FIG. 2A, the present embodiment utilizes a low voltage audio power amplifier LM386N Op Amp chip 152 (manufactured by National Semiconductor/Texas Instruments of Dallas, Tex.) and other components that supply an 8 ohm, 20 watt indoor/outdoor siren 158 with the audio for output. Various additional electronic components are typically required for a given implementation (as shown) and are generally known to those skilled in the art. Further discussion regarding non-specific components is omitted for the sake of brevity.

Communication module 170 serves to provide information exchange to/from external electronic units (not shown), which may include network specific communications (like network address request/assignment), gathered and stored information, database field information, triggering or timing events, remote display imagery, etc. Of course, various non-specific components may be required to enable specific functionality dependent upon a specific implementation, but these details are omitted for the sake of brevity, and are generally known to those skilled in the art. Communication module 170 acts as the liaison between the training apparatus 100 and any/all other electronic devices. This may also include USB connectivity, enabling information storage in EEPROM memory module(s) for easy transport to other computers.

As shown in FIG. 2A of the present embodiment, USB host bridge data logger 172, supplied by Parallax Inc. of Rocklin, Calif., is used to interface the training apparatus 100 with a USB flash drive (not shown) to send and store the data in an external memory unit. Typically, a USB flash drive is inserted into the data logger 172 and may be later inserted into a computer (not shown) via a USB port to process and analyze the data stored therein. Wired or wireless communication links (not shown) may also be used to transfer information to and from remote electronic devices, including personal data assistants (PDA) or smart phones running a corresponding application (not shown). This may be minimally implemented using a wireless communication method through an arbitrary wireless USB adaptor (not shown). It is well known to those skilled in the art how to implement information exchange between training apparatus 100 and other electronic devices in a variety of ways without departing from the spirit and scope of the present invention.

Display module 180 provides visual output to a user of the training apparatus 100 to enable data reporting, as well as current configuration and mode selection. As shown in FIG. 2A, the present embodiment discloses display module 180 as a serial 1602A 2×20 liquid crystal display (LCD) 182 (manufactured by WinStar Display Co., Ltd., of Taiwan) to display prompts and results to a user. However, it should be recognized any suitable output component may be utilized without departing from the spirit and scope of the present invention, including information transfer or duplication on remote electronic device display(s) (not shown). Further, other additional electronic components may be required for a particular implementation of an embodiment (as shown). Discussion regarding non-specific components is omitted for the sake of brevity, and is generally known to those skilled in the art.

User interface module 190 can be implemented in a variety of ways. As shown in FIG. 2A, a minimal keyboard 192 is used to enable data input into training apparatus 100 in the present embodiment comprising Enter Key 194, Up Arrow 195, and Down Arrow 196. Practically any type of user entry interface will work equivalently, provided the user is able to change and select entries for a given task of the training apparatus 100. Depending upon the specific implementation of a particular user interface module 190, including keyboard 192 utilized for the present embodiment, other additional electronic components may be required (as shown). Discussion regarding non-specific components is omitted for the sake of brevity, and is generally known to those skilled in the art.

Referring to FIG. 2A, clock module 195 implements a DS1302 Trickle-Charge Timekeeping Chip 199 (manufactured by National Semiconductor/Texas Instruments of Dallas, Tex.) and associated electronic components to store and manage date and time, which is maintained by a clock battery to avoid the requirement for reprogramming the date and time each time the training apparatus 100 is powered up. The DS1302 chip 199 provides the date and timestamp(s) which is used to derive timing data for recordation in memory module 130, flash drive memory (not shown) connected to USB port 172, and/or broadcast over communication module 170. In the current embodiment, timestamps are determined to 1/100th of a second, i.e., 0.01 seconds, to provide sufficient accuracy in recorded timing. It is noted any granularity of timing performed by clock module 195 may be suitably implemented without departing from the spirit and scope of the present invention.

Referring to FIG. 2B, power supply module 120 may comprise any type of suitable electrical power to run training device 100, including AC/DC adaptors, battery cells, solar cells, etc., which is capable of adequately powering all the required components of the present embodiment. Depending upon the specific implementation of a particular embodiment, other additional electronic components may be required (as shown). Discussion regarding non-specific components is omitted for the sake of brevity, and is generally known to those skilled in the art.

Referring to FIG. 2C, laser generation module 160 enables training apparatus 100 to be placed to the side of the sprinter (away from the field of action to avoid shock or damage) and enable a linear laser projector 162 to emit a projected laser line 169 which can be used as a starting line for the participant athlete. In the present embodiment, laser generation module 160 is a 3.3 volt generic laser diode. Of course, other types of light projection devices (e.g., LED, focused incandescent, etc.) may be implemented without departing from the spirit and scope of the invention. It is preferred that this projected laser line 169 directly correspond to a defined field of detection, so that motion sensor module 140 can easily determine motion at or over the projected laser line 169 to provide accurate starting time measurements and false start indications detailed below.

In the current embodiment, training apparatus 100 is configured to operate in two distinct modes of operation. When the training apparatus 100 operates in Automatic Mode, training apparatus 100 is configured to provide audio and visual displays for a variety of race start indicators (for example, “To your mark”, “Set”, “Go!”), project a start line 169 for reference by the athlete(s), detect false starts with a motion sensor, and collect, measure, and record timing and other related information for an unlimited, specified number of athletes. Typically, when operating in Automatic Mode, training apparatus 100 is placed at the start line to properly detect false starts and utilizes laser generation module 130 to project starting line 169 for the race visible to the athlete(s). When training apparatus 100 operates in Stop Watch Mode, training apparatus 100 is also configured to provide race start indicators, project start/finish line 169, and collect, measure, and record timing and other related information for an unlimited, specified number of athletes, but is disabled from detecting false starts. When operating in Stop Watch Mode, training apparatus 100 is typically placed at a desired distance (i.e., the finish line) to collect proper timing information and project a finish line 169 visible to the athlete(s).

The audio race start indicators are designed to simulate a starter at a track meet. At the start of a race, training apparatus 100 is configured to announce “Runners to your mark!” (or some other known, standardized audible indication). After a delay (roughly 20 seconds in the current embodiment) has elapsed, training apparatus 100 will announce an audible indication for “Set!”. As this point, training apparatus 100 will allow the runner two seconds to come to a set position at the blocks or starting line. This delay further enables the training apparatus 100 to determine an additional randomized delay to initiate the start signal (e.g., gunshot sound, or “Go!”).

After this delay elapses, motion sensor module 140 detects movement to indicate false starts when training apparatus 100 is running in Automatic Mode. Any motion detected by motion sensor module 140 after this delay to 0.1 seconds after the start signal is indicated as a false start. When this occurs, an audio tone is broadcast by audio generation module 150 (e.g., speaker 158), a false start is displayed by the display module 180 (e.g., LCD 182), and the false start is recorded by memory module 130, flash drive memory (not shown) connected to USB port 172, and/or broadcast over communication module 170 for recordation.

When no movement is detected by motion sensor module 140 during the period between the “Set!” delay to 0.1 seconds after the start signal, motion sensor module 140 waits to detect movement, records the timestamp of the movement, and subtracts the start signal timestamp from the timestamp of the movement to calculate the response time (in seconds). The response time is displayed by display module 180 and is recorded by memory module 130, flash drive memory (not shown) connected to USB port 172, and/or broadcast over communication module 170 for recordation.

The delay between “Runners to your mark!” and “Set!” is arbitrary, and generally static, and is programmed to be twenty seconds in the current embodiment which is unable to be modified by the user in the current embodiment. It is noted that any amount of time may be programmed to be used for this delay, with or without modification by a user, in addition to a randomized delay as detailed above without departing from the spirit and scope of the present invention.

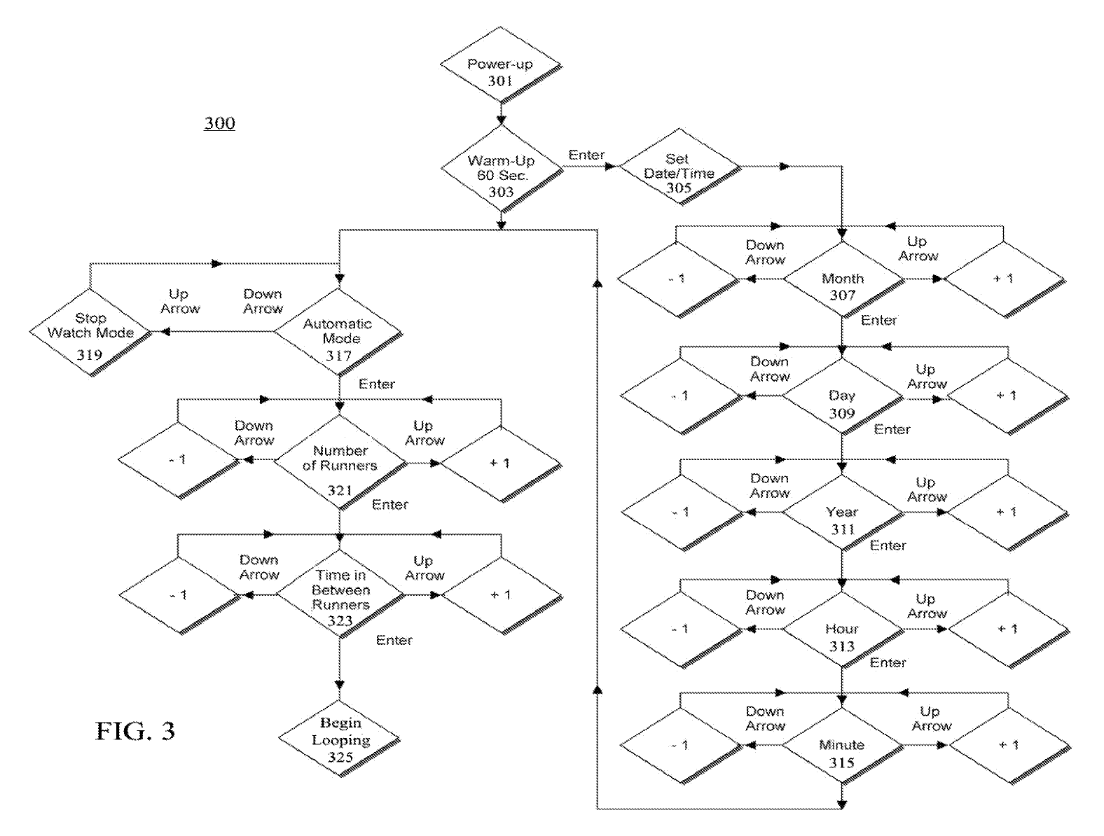

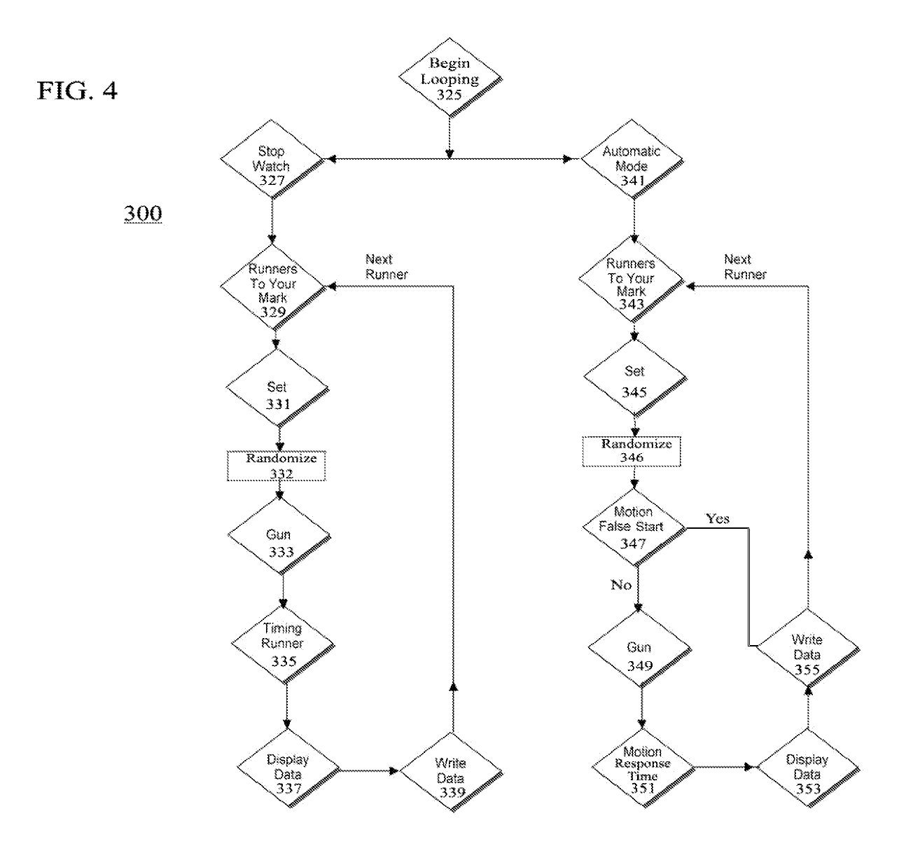

FIG. 3 and FIG. 4 display a flow chart process 300 for operation of the training apparatus 100 during operation in one embodiment of the invention.

In step 301, the training apparatus 100 performs a power-up operation, where power is supplied to power supply module 120, and subsequently, to all other components of the training apparatus 100. Various switches (not shown) may be employed for controlling power to training apparatus 100, motion sensor module 140, audio generation module 150, laser generation module 160, communication module 170, display module 180, and clock module 199, and are well within the knowledge of one skilled in the art. Details regarding such implementations of power switches are omitted for the sake of brevity.

After power-up, the process continues to step 303, where the training apparatus 100 performs a warming up process. In the current embodiment, the training apparatus 100 warm-up procedure lasts a minimum of 60 seconds for a number of reasons, including motion sensor module 140 requiring at least one minute to gather information about the environment and properly initialize. During this time, the date is displayed by display module 180 for an initial 20 seconds. After this time, the central processing module 110 begins to count down from 40 seconds to allow ample time for all the system components to properly initialize.

If no interaction occurs from the user during the display of date and time, the process continues to select a mode of operation for the training apparatus 100. In step 305, pressing a predetermined key on keyboard 192 (the Enter Key 194 is used for the present embodiment) during the warm-up process initiates a process in which the Date and Time are to be set.

In step 307, the user is prompted by the display module 180 to enter a value of the current month. In the current embodiment, pressing the Up Arrow 195 increments the current month and pressing the Down Arrow key 196 decrements the current month. The current month is set by pressing the Enter key 194.

In step 309, the process continues and the user is prompted by the display module 180 to enter a value of the current day. As above, pressing the Up Arrow 195 increments the current day, pressing the Down Arrow key 196 decrements the current day, and the current day is set by pressing the Enter key 194.

In steps 311-315, the process continues and the user is prompted by the display module 180 to enter a value of the current year, the current hour, and the current minute in the same fashion; pressing the Up Arrow 195 increments each current value, pressing the Down Arrow key 196 decrements each current value, and the value is set by pressing the Enter key 194. After the date and time are set, the process continues to select a mode of operation for the training apparatus 100.

In the current embodiment, the default mode of operation of the training apparatus 100 is Automatic Mode. Automatic mode may also be expressly selected by pressing the Down Arrow key 196. Stop Watch mode may be selected by pressing the Up Arrow key 195.

In step 317, the training apparatus 100 waits until a mode of operation is expressly specified by pressing the Enter Key 194.

In step 321, the process continues where a number of athletes is specified by incrementing the current number using the Up Arrow key 195, decrementing the current number of athletes by pressing the Down Arrow key 196, or selecting the currently specified number of athletes by pressing the Enter Key 194. At this time, it may be desirable to specify information to be stored in combination with the information gathered during this upcoming session specific to the athlete(s) and trial(s) including weather pattern(s), track conditions, fitted athlete equipment, and/or any other information desired to be combined with the specified gathered information. While not expressly shown, processing for these functions is well within the knowledge of one skilled in the art and is omitted for the sake of brevity. Any suitable information which relates to the athlete(s) of the trials may be recorded and entered at this stage.

Additionally, a number of specified trials may also be specified prior to the measurement looping for the trials. This will cause the number of loops of the measurement and recording process to continue until all the specified trials are exhausted instead of requiring express cancellation by the user.

In step 323, an interval which specifies a uniform (predetermined) time delay to use between athletes for successive trials is set by the user. This delay dictates how long the training apparatus 100 will wait between completions (i.e., the end and subsequent start) of a race or trial. That is, the user specifies the time the end of a trial and the experienced time delay when the next athlete is called to the mark to begin a new trial. The default value in this embodiment is 15 seconds. This value may be specified by incrementing the current value using the Up Arrow key 195, decrementing the current number of athletes by pressing the Down Arrow key 196, or selecting the currently specified value by pressing the Enter Key 194.

In step 325, the training apparatus 100 is now configured to begin gathering and recording information regarding each of the athletic trials in a looping process. The training apparatus 100 enters a programmatic loop until all gathered and derived information is stored, the number of trials is exhausted, or the process is manually cancelled by the user.

The loop process may be specifically determined by the mode of operation chosen for the training apparatus 100. For example, in step 327, when the training apparatus 100 is operating in the Stop Watch mode, the first athlete is called to the mark in step 329. At this time (or alternatively prior to being called to mark as detailed above), information specific to the particular runner or trial may be specified, including weather pattern(s), track conditions, fitted athlete equipment, and/or any other information desired to be stored in combination with the specific athlete or trial. This information is stored in memory module 130 along with all other gathered and derived information for the specific trial. While not expressly shown, interaction with the user and processing for these functions are well within the knowledge of one skilled in the art and are omitted for the sake of brevity. Training apparatus 100 indicates athlete number, stored information, and the current state of the loop and information gathering/recording process through use of the audio generation module 150 and/or display module 180.

In step 331, after a delay (roughly 20 seconds in the current embodiment) has elapsed, the training apparatus 100 will announce an audible indication for “Set!”, again through use of the audio generation module 150 and/or the display module 180. It is further possible that a user may manually suspend (i.e., pause) the process during this delay period, causing the delay period to resume after the pause is terminated.

In step 332, the training apparatus 100 determines an additional randomized delay to initiate the trial start signal (one to three seconds in the preferred embodiment).

In step 333, the training apparatus 100 engages the audio generation module 150 and display module 180 to indicate the trial has started (e.g., with a gunshot sound, or “Go!”).

In step 335, training apparatus 100 records a beginning timestamp of the trial start signal and maintains a running record of elapsing time for the trial. When operating in Stop Watch mode, the training apparatus 100 waits until an indication that the trial has ended, either by manual actuation of a button, a signal received from motion sensor module 140, or a signal received from an additional motion sensor module (not shown).

In step 337, a timestamp for the trial end time is recorded, the duration of the time is determined, and display of the elapsed time occurs. Alternative to the microcontroller 112 using a strict timer, the microcontroller 112 may also derive the elapsed time by subtracting the begin timestamp from the end timestamp to obtain an elapsed time for the trial.

In step 339, the elapsed time data, along with all the other data associated with the record is written by memory module 130, flash drive memory (not shown) connected to USB port 172, and/or broadcast over communication module 170 for recordation for future access and analysis.

After the data has been written into the memory module 130, the number of the athlete is incremented, the delay specified in step 323 may be introduced, and flow returns to step 329 for further recording information for trials. The training apparatus 100 continues to operate in Stop Watch mode until all the athletes specified in step 321 have associated and written data for each trial, and repeats the entire operation beginning again with the first athlete. If a number of trials have been specified, the training apparatus 100 will gather information for the specified trials. Alternately, the user may manually cancel the process at any time.

In step 341, when it is determined that the training apparatus 100 is operating in Automatic Mode, the first athlete is called to the mark in step 343. As above, at this time (or alternatively prior to being called to mark as detailed above), information specific to the particular runner or trial may be specified, including weather pattern(s), track conditions, fitted athlete equipment, and/or any other information desired to be stored in combination with the specific athlete or trial. This information is stored in memory module 130 along with all other gathered information for the specific trial. While not expressly shown, interaction with the user and processing for these functions are well within the knowledge of one skilled in the art and are omitted for the sake of brevity. The training apparatus 100 indicates athlete number, stored information, and current state of the loop and information gathering/recording process through use of the audio generation module 150 and/or display module 180.

In step 345, after a delay (roughly 20 seconds in the current embodiment) has elapsed, training apparatus 100 will announce an audible indication for “Set!” through use of the audio generation module 150 and/or display module 180, and training apparatus 100 will allow the athlete an adequate delay time (two full seconds in the preferred embodiment) to come to a set position at the blocks or starting line without risking false start motion detection by motion sensor module 140.

In step 346, training apparatus 100 determines an additional randomized delay to initiate the trial start signal (one to three seconds in the preferred embodiment).

In step 347, after this initial delay elapses, any motion detected by motion sensor module 140 up to 0.1 seconds after the start signal is indicated as a false start. When motion occurs during this period (i.e., is detected by the motion detector beyond some predetermined threshold or amount), an audio tone is broadcast by audio generation module 150 (e.g., speaker 158) indicating a false start. An indication of a false start is also displayed by the display module 180 (e.g., LCD 182).

In step 355, the false start (and other) information is then recorded by memory module 130, flash drive memory (not shown) connected to USB port 172, and/or broadcast over communication module 170 for recordation. Flow continues by incrementing the number of the athlete, the delay specified in step 323 is introduced prior to a new trial, and flow returns to step 343 for the next trial. As detailed above, training apparatus 100 will determine an additional (new) randomized delay to initiate the trial start signal in step 346.

In step 349, if there is no indication of false start, the audio generation module 150 and display module 180 indicate the trial has started (e.g., with a gunshot sound, or “Go!”).

In step 351, when insufficient movement is detected by motion sensor module 140 during the randomized period between the “Set!” delay to 0.1 seconds after the start signal, motion sensor module 140 waits to detect movement, records the timestamp of the movement, and subtracts the start signal timestamp from the timestamp of the detected movement to calculate the response time (in seconds).

Granularity for the measurement of time and timestamps in the current embodiment is 0.01 seconds. Of course, implementing any level of precision in regard to timing are well within the knowledge of one skilled in the art and are omitted for the sake of brevity.

In step 353, the response time may be displayed by display module 180.

In step 355, the response time is recorded by memory module 130, flash drive memory (not shown) connected to USB port 172, and/or broadcast over communication module 170.

After the data has been written, the trial is considered complete, the number of the athlete is incremented, the delay specified in step 323 is introduced, and flow returns to step 343. When the training apparatus 100 continues to operate in Automatic mode, this flow continues until all the athletes specified in step 321 have associated and written data, and repeats the entire operation beginning again with the first athlete until the number of trials (if specified) is exhausted. Alternately, the user may cancel the process at any time.

It should be noted that collected information is sequentially stored in memory module 130, flash drive memory (not shown) connected to USB port 172, and/or broadcast over communication module 170, such that information once written is never lost or written over, even if the process is cancelled (by user or there is a system crash). This provides strong data integrity for all gathered, derived, and stored information.

It is noted that while this embodiment shows a particular flow of operations and process of information gathering and information output, there is no requirement for other embodiments of the invention to be so restricted. A skilled artisan may implement the operation of the device in various ways without departing from the spirit and the scope of the invention.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An apparatus for athlete training, information gathering, and information recording, comprising:
a power supply means, for supplying power to a plurality of components of the apparatus;
a timing means, for providing time data;
a user interface means for receiving user input;
a non-volatile memory means, for digitally storing, for each of a plurality of respective trials, a corresponding record related to the respective trial;
a motion detection means for determining, for each of the plurality of respective trials, a reaction time for movement beyond a predetermined threshold measured in relation to a start time of the respective trial;
a processing means for:
generating, for each of the plurality of respective trials, a randomized delay after a set time and prior to the start time of the respective trial;
determining, for each of the plurality of respective trials, either an indication of a false start when the reaction time occurs prior to the start time or an elapsed time for the respective trial when the reaction time occurs after the start time; and
writing, in the non-volatile memory means, for each of the plurality of respective trials, the corresponding record including an indication of a false start when the reaction time occurs prior to the start time, or the start time, an end time, the reaction time, and an elapsed time for the respective trial when the reaction time occurs after the start time;
an audio subsystem means for audibly providing, for each of the plurality of respective trials, an indication of the set time, the start time, and an alarm when a false start is determined; and
a display means for displaying, for each of the plurality of respective trials, an indication of information contained in the corresponding record of the respective trial.

2. The apparatus of claim 1, further comprising a laser generation means for projecting a visual starting line for each respective trial.

3. The apparatus of claim 1, wherein the non-volatile memory means includes a secondary, removable memory module.

4. The apparatus of claim 3, further comprising a communication means, for transmitting the corresponding record to the non-volatile memory means.

5. The apparatus of claim 1, wherein the user input specifies one or more of a plurality of operating modes for the apparatus, a number of participants for recording the plurality of respective trials, and a time delay indicating a pause time prior to each of the plurality of respective trials.

6. The apparatus of claim 5, wherein the operating modes for the apparatus include an automatic mode for automated information gathering at the beginning of each of the plurality of respective trials, and a stop watch mode for gathering and recording timing information at the conclusion of each of the plurality of respective trials.

7. The apparatus of claim 1, wherein each corresponding record further includes, for each of the plurality of respective trials, a current date and a current time for the respective trial.

8. An apparatus for athlete training, information gathering, and information recording, comprising:
a clock, configured for providing time data;
a user interface, configured to receive user input;
a non-volatile memory, configured to digitally store, for each of a plurality of respective trials, a corresponding record related to the respective trial;
a motion detector, configured to determine, for each of the plurality of respective trials, a reaction time for movement beyond a predetermined threshold measured in relation to a start time of the respective trial;
a central processing unit, configured to:
generate, for each respective trial, a randomized delay after a set time and prior to the start time of the respective trial;
determine, for each respective trial, either an indication of a false start when the reaction time occurs prior to the start time or an elapsed time for the respective trial when the reaction time occurs after the start time; and
write, in the non-volatile memory, for each of the plurality of respective trials, the corresponding record including an indication of a false start when the reaction time occurs prior to the start time, or the start time, an end time, the reaction time, and an elapsed time for the respective trial when the reaction time occurs after the start time;
an audio subsystem, configured to audibly provide, for each of the plurality of respective trials, an indication of the set time, the start time, and an alarm when a false start is determined; and
a display device, configured to display, for each of the plurality of respective trials, an indication of information contained in the corresponding record of the respective trial.

9. The apparatus of claim 8, further comprising a laser device configured to project a visual starting line for each of the plurality of respective trials.

10. The apparatus of claim 8, wherein the non-volatile memory includes a secondary, removable memory module.

11. The apparatus of claim 8, wherein the user input specifies one or more of a plurality of operating modes for the apparatus, a number of participants for recording the plurality of respective trials, and a time delay indicating a pause time prior to each respective trial.

12. The apparatus of claim 11, wherein the operating modes for the apparatus include an automatic mode for automated information gathering at the beginning of a respective trial, and a stop watch mode for gathering and recording timing information at the conclusion of a respective trial.

13. The apparatus of claim 1, wherein each corresponding record further includes, for each of the plurality of respective trials, a current date and a current time for the respective trial.

14. The apparatus of claim 1, wherein each corresponding record further includes, for each of the plurality of respective trials, values indicating outfitted equipment, weather conditions, or track conditions associated with the respective trial.

15. A computer-enabled method for athlete training, information gathering, and information recording, comprising:
one or more user interfaces, configured to receive user input;
one or more non-volatile memories, configured to digitally store, for each of a plurality of respective trials, a corresponding record related to the respective trial;
one or more display devices, configured to display, for each of the plurality of respective trials, information contained in the corresponding record of the respective trial; and
one or more central processing units, wherein at least one of the central processing units is configured to:
determining, for each of the plurality of respective trials, a reaction time for movement beyond a predetermined threshold measured in relation to a start time of the respective trial;
generating, for each respective trial, a randomized delay after a set time and prior to the start time of the respective trial;
determining, for each of the plurality of respective trials, either an indication of a false start when the reaction time occurs prior to the start time or an elapsed time for the respective trial when the reaction time occurs after the start time; and
writing, in at least one of the one or more non-volatile memories, for each of the plurality of respective trials, the corresponding record including an indication of a false start when the reaction time occurs prior to the start time, or the start time, an end time, the reaction time, and an elapsed time for the respective trial when the reaction time occurs after the start time; and
providing, for each of the plurality of respective trials, an audible indication of the set time, the start time, and an alarm when a false start is determined.

16. The method of claim 15, further comprising projecting a visual starting line for each of the plurality of respective trials.

17. The method of claim 15, further comprising transmitting, for each of the plurality of respective trials, the corresponding record to a secondary, removable memory module.

18. The method of claim 15, wherein the user input specifies a current date and time, one or more of a plurality of operating modes for the one or more central processing units, a number of the plurality of respective trials, and a time delay indicating a pause time prior to each of the plurality of respective trials.

19. The method of claim 18, wherein the one or more of a plurality of operating modes for the apparatus include an automatic mode for automated information gathering at the beginning of a respective trial, and a stop watch mode for gathering and recording timing information at the conclusion of a respective trial.

20. The method of claim 18, wherein each corresponding record further includes, for the respective trial, the current date and the current time for the respective trial.
